(19) United States
(12) Patent Application Publication
(10) Pub. No.: US 2013/0128326 A1
(43) Pub. Date: May 23, 2013

(54) LIGHT ABSORBING FILM FOR HOLOGRAPHIC PROCESSING AND METHOD OF USING SAME

(71) Applicant: Prism Solar Technologies Incorporated, Highland, NY (US)

(72) Inventors: Eric D. Aspnes, Tucson, AZ (US); Jose E. Castillo, Tucson, AZ (US); Ryan D. Courreges, Tucson, AZ (US); Paul S. Hauser, Tucson, AZ (US); Glenn Rosenberg, Tucson, AZ (US); Juan Manuel Russo, Tucson, AZ (US)

(73) Assignee: PRISM SOLAR TECHNOLOGIES INCORPORATED, Highland, NY (US)

(21) Appl. No.: 13/680,561

(22) Filed: Nov. 19, 2012

Related U.S. Application Data
(60) Provisional application No. 61/561,384, filed on Nov. 18, 2011.
(60) Provisional application No. 61/563,371, filed on Nov. 23, 2011.

(51) Int. Cl. G03H 1/04

(52) U.S. Cl. CPC G03H 1/04
USPC 359/15; 430/2

(57) ABSTRACT

A novel light absorbing holographic film for holographic processing is present. The holographic film includes a light absorbing film having a holographic medium disposed thereon. The light absorbing film comprises a substrate and a light absorption layer disposed on a first surface of the substrate. In certain embodiments a second light absorption layer is disposed on a second, opposing surface of the substrate. In other embodiments, a second absorption layer is disposed on top of the first absorption layer.

### CROSS REFERENCE TO RELATED APPLICATIONS

This application claims priority to, and the benefit of, U.S. Provisional Patent Application Ser. No. 61/561,384, filed on Nov. 18, 2011, titled “Light Absorbing Film for Holographic Processing and Method of Using Same,” and to U.S. Provisional Application Ser. No. 61/563,371, filed on Nov. 23, 2011, titled “Light Absorbing Film for Holographic Processing and Method of Using Same,” the entire contents of both of which are incorporated herein by reference.

### BACKGROUND OF THE INVENTION

A hologram is a three dimensional image recorded onto a holographic medium. Holograms are created by forming holographic structures on the holographic medium. Incident light striking the hologram interacts with the holographic structures and undergoes diffraction. To a viewer, the diffracted light is perceived as a three-dimensional image.

Holograms have a number of uses, including for example, as artwork, in security and anti-counterfeiting devices, as a data storage medium, and to enhance solar power production. Certain applications, such as data storage and solar power production, require a high quality hologram, where the image recorded in the holograph is a very accurate representation of the actual or intended image.

Holograms are often produced by processing the holographic medium in a continuous roll-to-roll process. By “roll-to-roll” it is meant that the holographic media from a roll of unexposed film is fed through an imaging chamber and wound onto a second roll after exposure. Any stray light caused by unwanted reflection during exposure has the potential to create undesired holographic structures in the holographic medium, thereby reducing the quality of the holographic image. Non-optimal holographic elements result in holograms that differ from the original or intended image, thereby impacting the holograms performance in certain applications.

Accordingly, it would be an advance in the state of the art to provide a system and method capable of absorbing stray light generated during exposure of the holographic medium during roll to roll holographic processing so as to increase the quality of the resulting hologram.

### SUMMARY

In one implementation, a novel light absorbing holographic film for holographic processing is present. The holographic film includes a light absorbing film having a holographic medium disposed thereon. The light absorbing film comprises a substrate and a light absorption layer disposed on a first surface of the substrate. In certain embodiments a second light absorption layer is disposed on a second, opposing surface of the substrate. In other embodiments, a second absorption layer is disposed on top of the first absorption layer.

In another implementation, a system for processing holographic film is presented. The system includes a first source roll of flexible unexposed holographic film having a holographic medium and a second source roll of flexible light absorbing film that comprises a substrate and a light absorption layer disposed on a first surface of the substrate. The system further comprises an imaging chamber and a feed mechanism configured to bring a portion of the flexible light absorbing film into contact with a portion of the flexible unexposed holographic film within the imaging chamber prior to exposing the portion of the flexible unexposed holographic film to light.

In yet another embodiment, a method for processing holographic film is presented. The method including providing a light absorbing film having a substrate with a first surface and a first absorption layer disposed on the first surface of the substrate. The method further includes disposing the light absorbing film on a holographic medium and exposing the holographic medium to light.

In yet another embodiment, a light absorbing film for holographic processing is presented. The light absorbing film comprises a substrate having a first surface; and a first light absorption layer disposed on the first surface of the substrate, where the light absorption layer is a colloidal mixture of gelatin and an absorption medium.

### BRIEF DESCRIPTION OF THE DRAWINGS

The invention will be better understood from a reading of the following detailed description taken in conjunction with the drawings in which like reference designators are used to designate like elements, and in which:

FIG. 1 is a schematic of a holographic planar concentrator;

FIG. 2A shows an embodiment of a holographic spectrum-splitting device;

FIG. 2B shows an alternative embodiment of a holographic spectrum-splitting device;

FIG. 3A is a diagram showing the exposure of a holographic medium;

FIG. 3B is a diagram showing the exposure of a holographic medium lined with light absorbing film;

FIG. 4A is a diagram of one embodiment of Applicants' light absorbing film;

FIG. 4B is a diagram of alternative embodiment of Applicants' light absorbing film;

FIG. 4C is a diagram of another alternative embodiment of Applicants' light absorbing film;

FIG. 5 is a diagram of a dual-layer flexible absorbing film;

FIG. 6A is a diagram of a system for continuous processing of a holographic medium using Applicants' flexible light absorbing film;

FIG. 6B is a diagram of an alternative system for continuous processing of a holographic medium using Applicants' flexible light absorbing film; and

FIG. 7 is a flowchart of an exemplary method of making Applicants' flexible light absorbing film and using the same to produce a hologram.

### DETAILED DESCRIPTION OF PREFERRED EMBODIMENTS

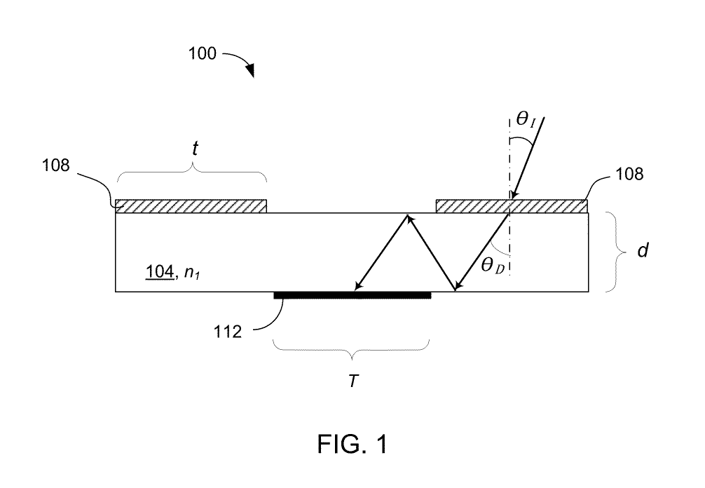

An holographic planar concentrator (HPC) 100, shown schematically in a cross-sectional view in FIG. 1, typically includes a highly-transparent planar substrate 104 of thickness d (such as, for example, substrate made of glass or appropriate polymeric material having the refractive index n₁) at least one diffractive structure 108, having width t, at a surface of the substrate 104. Such diffractive structure may include, for example, a holographic optical film in which a plurality of multiplexed diffraction gratings have been recorded with the use of laser light. The diffractive structure 108 can be optionally capped with a protective cover layer (not shown). The substrate 104 is typically cooperated with a solar-energy-collecting device 112 such as a PV cell. The diffractive structures 108 diffract wavelengths usable by the PV cell 112, while allowing the light at unusable wavelength to pass through, substantially unabsorbed. The usable energy is guided via the total internal reflection at the glass/air or glass/cover interface to strings of solar cells, resulting in up to a 3× concentration of solar energy per unit area of PV material.

As shown in FIG. 1, the PV cell 112 of width T is juxtaposed with the second surface of the substrate 104 in opposition to the diffractive structures 108 and in such orientation that ambient (sun) light I, incident onto the structure 108 at an angle, is diffracted at an angle onto the cell 112 either directly or upon multiple reflections within the substrate 104. A precise hologram (i.e., with few or no undesired holographic structures) is necessary to optimize the light directed onto cell 112. To estimate the range of incident angles that would produce the diffracted light intersecting the surface of the PV cell 112 for different parameters of the HPC 100 such as substrate thickness, the displacement of the PV cell 112 with respect to the edge of the grating 108, other geometrical parameters one can use the grating equation. For example, for a glass substrate 104 and when, the range of incident angles (the collection angle) at which the cell 112 is illuminated is about 45 degrees. When the collection angle is reduced to about 38 degrees, the angular range within which the corresponding diffracted light is produced is about 10° to 15° for most of the wavelengths. However, the angle-wavelength matching can be used to extend this range for different portions of the available spectral bandwidth of the HPC 100.

The increase in PV-conversion efficiency, in comparison with a use of a conventional PV-cell, is also achieved by using multiple junction cells that create electron-hole pairs at the expense of energy of incident light over a wider spectral range than a single junction cell. The use of holographic grating with such spectrum-splitting devices (SSD) also offers some advantages. The hologram can be designed to diffract light within a specific spectral band in a desired direction (for example, towards one PV-cell) and be multiplexed with another hologram that diffracts light of different wavelength in another direction (for example, towards another PV-cell). A precise hologram (i.e., with few or no undesired holographic structures) is necessary to optimize the amount of light diffracted within the specific spectral band.

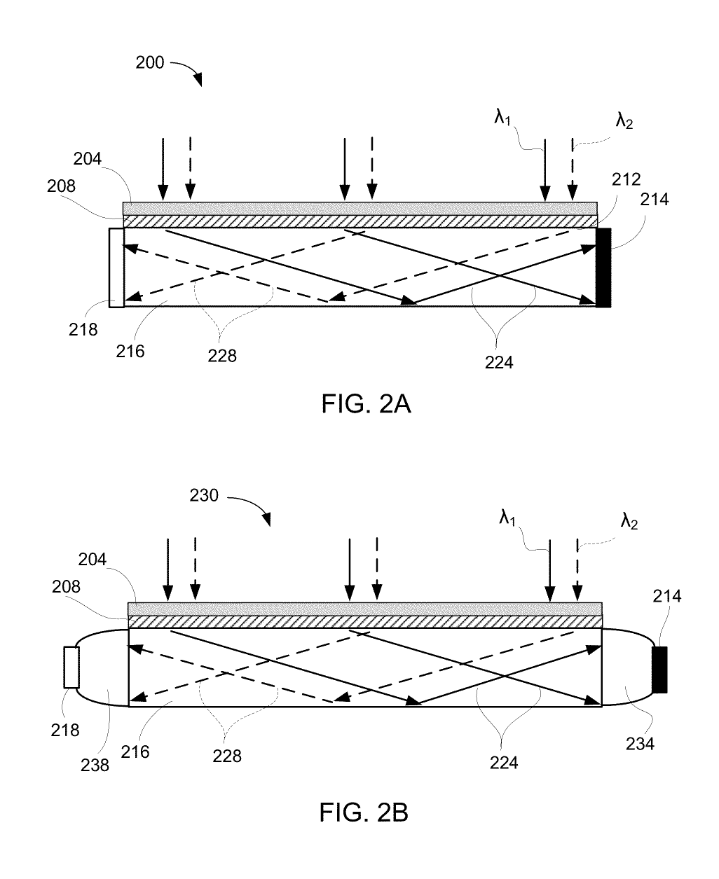

One example of a holographic SSD 200, shown in FIG. 2A, includes two holographically-recorded diffractive structures 204 and 208 that are cascaded at a surface 212 of the substrate 216 (i.e., at the input of the SSD 200) and that diffract light of different wavelengths. For example, the upper hologram 204 diffracts light at a wavelength longer than the wavelength diffracted by the hologram 208. Two PV-cells, respectively-corresponding to the holograms 204 and 208—a long-wavelength PV cell 214 and a short-wavelength PV-cell 218—are positioned transversely with respect to the holograms 204, 208 (as shown, at side facets of the substrate 216). Directionally-diffracted towards target PV-cells, light 224, 228 reaches the PV-cells via reflections off the surfaces of the substrate 216. A simple light-concentrating reflector can additionally be used. A similar SSD 230, upgraded with cylindrical parabolic reflectors 234, 238 that guide the diffracted light towards target PV-cells, is depicted in FIG. 2B. In both cases, the collection angle is determined by geometry of the system and the diffraction characteristics of the holograms. A precise hologram (i.e., with few or no undesired holographic structures) is necessary to optimize the quality (i.e., desired spectral band) and amount of light directed to target PV-cells.

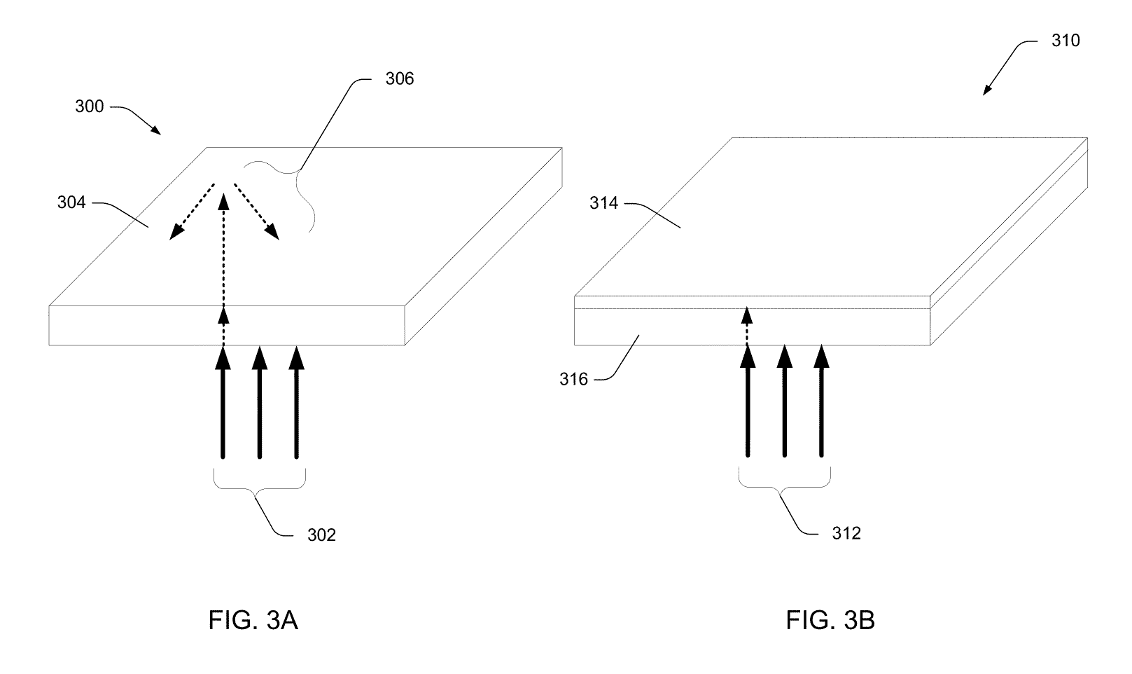

Referring to FIG. 3A, a diagram 300 depicts the exposure of a holographic medium. Light 302 is directed onto the holographic medium 304. Light 302 exposes portions of the medium 304 to create holographic structures in the medium 304. A portion of the light 302 is absorbed by the holographic medium 304. Another portion of the light passes through the holographic medium 304 without being absorbed. This stray tight has the potential to reflect back, as indicated by 306, and to cause unwanted exposure of the holographic medium. The stray light can be reflected back from surfaces within the exposure chamber on the surface of the holographic medium opposite the light source or through Fresnel reflection at the holographic medium/air (or holographic medium/liquid, depending on the method of exposure) boundary opposite the light source. The holographic structures created by the unwanted exposure reduce the efficiency of the holographic film in the HPC concentrator.

Referring to FIG. 3B, a diagram 310 depicts the exposure of a holographic medium having a light absorbing film according to one embodiment of the present invention. As is described further in detail, light 312 exposes portions of the medium 316 to create holographic structures in the medium. The portion of the light that passes through the holographic medium is absorbed by the absorbing film 314, thereby eliminating the stray light and any associated unwanted exposure.

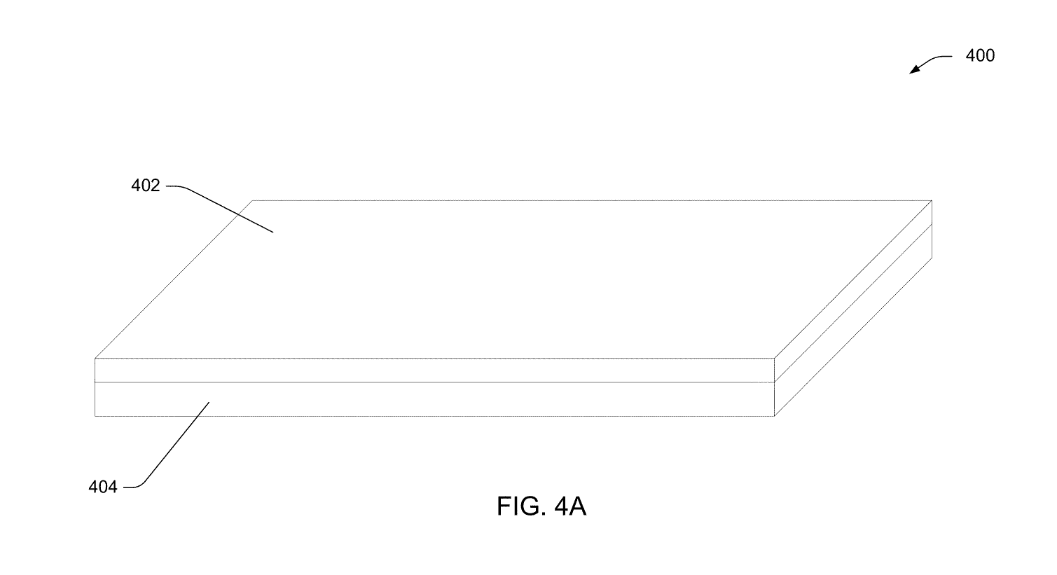

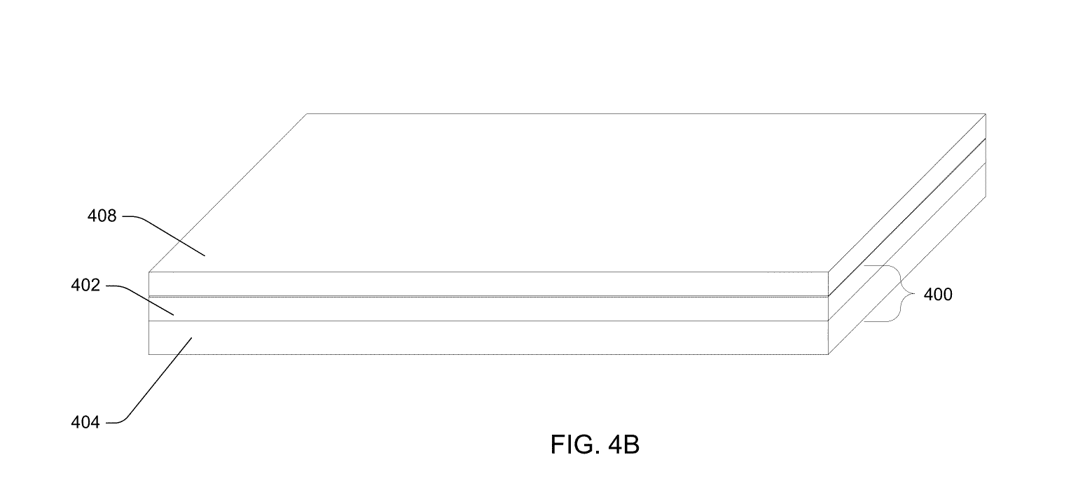

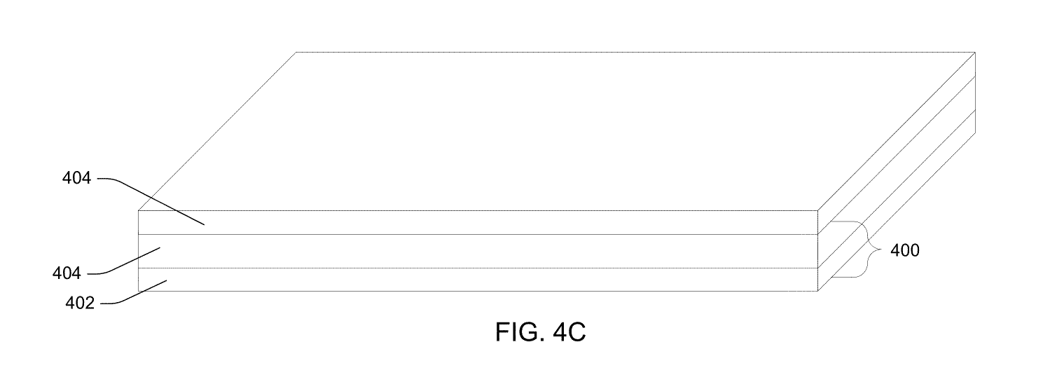

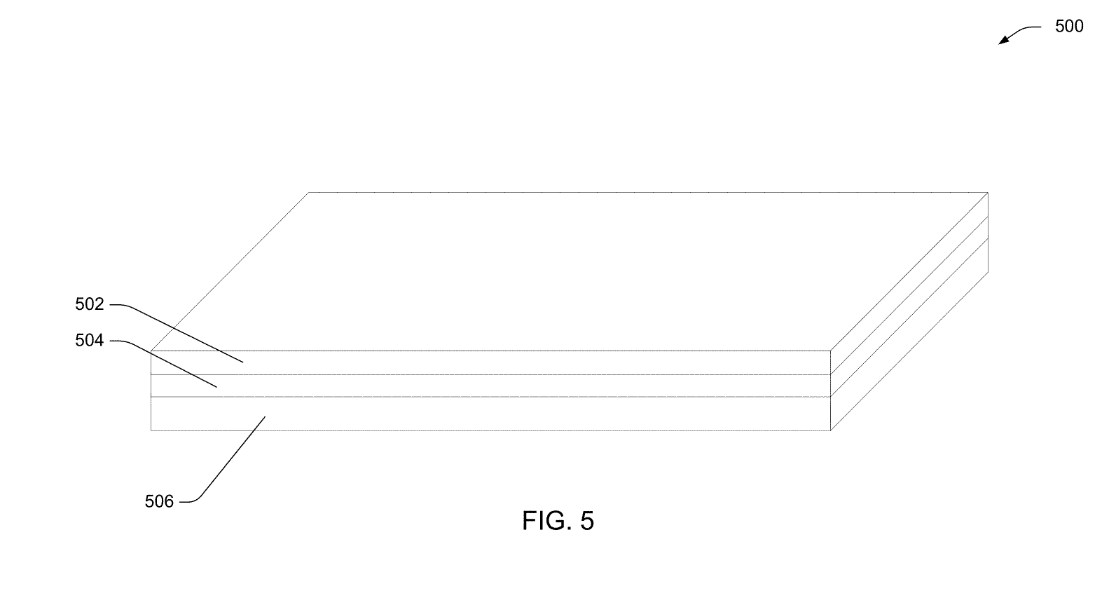

Referring to FIG. 4A, a block diagram of one embodiment of the light absorbing film 400 is depicted. As can be seen in FIG. 4A, light absorbing film 400 comprises at least one absorption layer 402 disposed on a flexible substrate 404. In one embodiment, the substrate is polyethylene terephthalate (PET). In one embodiment, the substrate is transparent. In one embodiment, the substrate is non-reflective. In one embodiment, the substrate has a thickness between approximately 50 and approximately 1,000 microns, wherein by “approximately” it is meant ±5%. In one embodiment, the substrate has a thickness of approximately 100 microns.

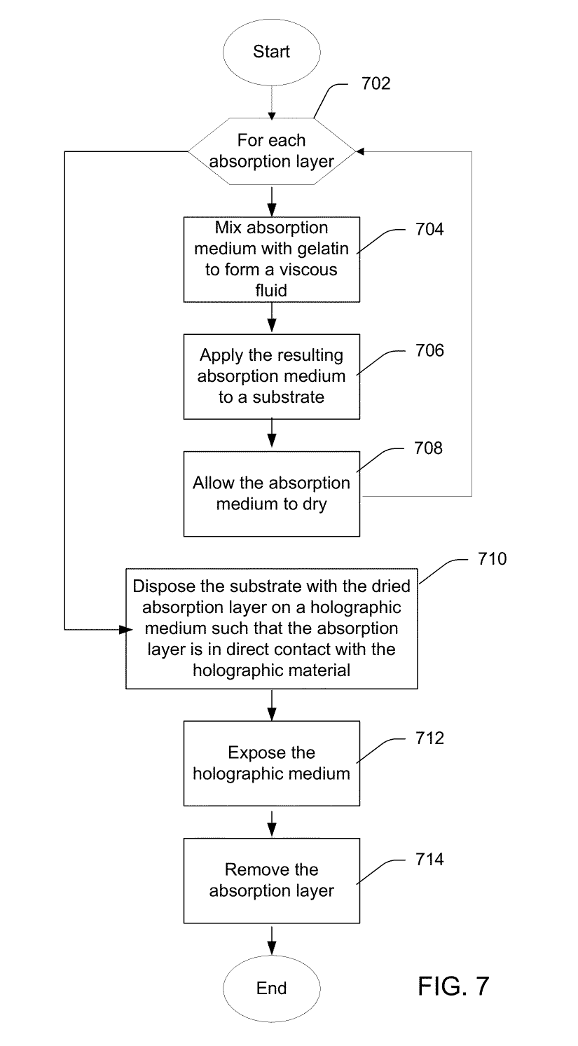

FIG. 7 depicts a block diagram of a method of making and using light absorbing film 400 to create a holographic film. As is indicated by blocks 702 and 704, to create an absorption layer, such as layer 402 of FIG. 4A, an absorption medium is mixed with gelatin to form a viscous fluid. In one embodiment, the gelatin layer comprises colloidal gelatin. In various embodiments, the gelatin comprises between approximately 40% water to approximately 90% water. In various embodiments, the gelatin comprises between approximately 60% water to approximately 80% water. In one embodiment, the gelatin comprises approximately 70% water.

In certain embodiments the absorption medium comprises a dye capable of absorbing a target wavelength or range of wavelengths. Further, in certain embodiments the absorption medium may comprise other materials that are (i) capable of being dissolved or suspended in the gelatin layer, (ii) that exhibit absorption characteristics at a useable thickness, and (iii) that are non-reflective. In such embodiments, the absorption medium may comprise a dichromate compound, such as and without limitation potassium dichromate or ammonium dichromate. In certain other embodiments the absorption medium comprises a silver halide. In yet other embodiments the absorption medium comprises carbon black, an amorphous carbon that has a high surface area/volume ratio.

The fluid resulting from the mixture of the absorption medium with colloidal gelatin is applied to a substrate, such as substrate 404 (FIG. 4A), and allowed to dry to form a colloidal gelatin layer of a final thickness, as indicated by blocks 706 and 708. The method used to apply the absorption medium can be any of a number of known methods, including roll-to-roll processing and sputtering deposition, depending on the substrate used. By way of example and not limitation, in certain embodiments where the substrate is a flexible substrate such as PET, a roll of the substrate may be coated with the absorption medium via roll to roll processing to form a role of flexible, light absorbing film.

The final thickness of the colloidal gelatin layer is determined by the Beer-Lambert Law (I) and is a function of the absorption constant of the colloidal gelatin, determined in part by the choice of dye/absorption material, and the desired absorbance.

% transmittance=100*e^{(-t*a)} (1)

where, t is the thickness of the gelatin layer and a is the absorption constant of the gelatin layer. The absorption constant is, in turn, a function of the choice of dye/absorption material used. While the thickness of the final colloidal gelatin layer applied can be calculated from the exact absorbance needed, in certain embodiments it is preferred to calculate the final thickness from a greater than necessary absorbance. As will be appreciated, increasing the thickness of the final colloidal gelatin layer to further decrease the percent transmission further ensures that all stray light is absorbed and does not degrade the final hologram. In certain embodiments the percent transmission used to calculate the thickness of the dried gelatin layer is ten times lower than required. In other embodiments the percent transmission used to calculate the thickness of the dried gelatin layer is less than ten times lower than required. In yet other embodiments the percent transmission used to calculate the thickness of the dried gelatin layer is less than ten times lower than required. In various embodiments, the thickness of the dried gelatin layer is approximately 30 micrometers or less. In various embodiments, the thickness of the dried gelatin layer is greater than 30 micrometers.

In certain embodiments the absorption layer 402 is a colloidal gelatin layer indexed matched to the substrate 404. In other words, the index of refraction of the colloidal gelatin layer 402 matches the index of refraction of the substrate 404. As will be appreciated, where the index of refraction of the colloidal gelatin layer 402 is not matched with the substrate 404, at hologram/air boundary (or hologram/liquid boundary, depending on the exposure method), the difference in the index of refraction between the holographic medium and the air will cause some light passing through the holographic medium to reflect off the hologram/air boundary and back onto the holographic medium. Referred to as “Fresnel reflection,” this reflected light can cause aberrations in the resulting hologram, thereby degrading its quality. However, by index matching the colloidal gelatin one can reduce the Fresnel reflection significantly.

The steps indicated by blocks 702-708 of FIG. 7 are repeated for each absorption layer desired. One such embodiment of the present invention having multiple absorption layers is depicted in FIG. 5. As can be seen, a first absorption layer 504 is disposed on a substrate 506. As with the single layer absorption film depicted in FIG. 4A, the first absorption layer may be a colloidal gelatin layer and the substrate may be a flexible PET. A second absorption layer 502 is then disposed on the first absorption layer 504. In certain embodiments the second absorption layer 502 is also a colloidal gelatin layer as described herein.

In certain embodiments the first absorption layer 504 is configured to absorb a different wavelength of light as the second absorption layer 502, thereby allowing target wavelengths to pass unhindered. In certain such embodiments, either the first absorption layer 504 or the second absorption layer 502 is configured to absorb blue/green wavelengths. In other such embodiments either the first absorption layer 504 or the second absorption layer 502 is configured to absorb red wavelengths.

In certain embodiments the first absorption layer 504 is angle dependant. In such an embodiment, absorption layer 504 increasingly absorbs light the greater the angle is from normal and will thus absorb stray light which reflects from the air (or other medium)/absorption layer 504 interface or the absorption layer 504/substrate 404 interface due to Fresnel reflection. As will be appreciated, if not absorbed by layer 504, such light has the ability to reflect off of surfaces back onto the holographic medium, thereby causing further aberrations.

As will be appreciated, while FIG. 5 depicts a dual-layer absorbing film 500, the method indicated by blocks 702-708 of FIG. 7 can be used to create absorbing films having more than two layers without departing from the scope of the present invention. In such embodiments, each absorption layer may be configured to absorb a different wavelength and may be indexed matched with the particular substrate used.

To create a hologram, the resulting light absorbing film is disposed on a holographic medium such that the absorption layer is in direct contact with the holographic medium, as indicated by block 710 of FIG. 7. It should be appreciated that to dispose the light absorption film on the holographic medium is the same as to dispose the holographic medium on the absorption film, and that as used herein, the terms “disposed on” or “disposing” refer to both manners.

FIG. 4B provides an illustration of the resulting stack, wherein the light absorbing film 400 is disposed on holographic medium 408 such that the absorption layer 402 is in direct contact with the holographic medium 408 and the substrate 404 is on the side of the absorption layer 402 opposite that of the holographic medium 408. Where the absorption layer 402 is an index-matched colloidal gelatin material, the Fresnel effects will be minimized and light will pass directly into the gelatin layer with little or no reflection or refraction. Light passing into the absorption layer 402 is absorbed and thereby prevented from reflecting back into the holographic medium. In one embodiment, light passing into the absorption layer 402 is completely absorbed by the absorption layer 402.

In alternate embodiments, the light absorbing film 400 may be disposed in opposite of what is shown in FIG. 4B. More specifically, as illustrated in FIG. 4C, the light absorbing film 400 may be disposed on the holographic medium 408 such that the absorption layer 402 is on the opposite side of the substrate 404 from the holographic medium 408.

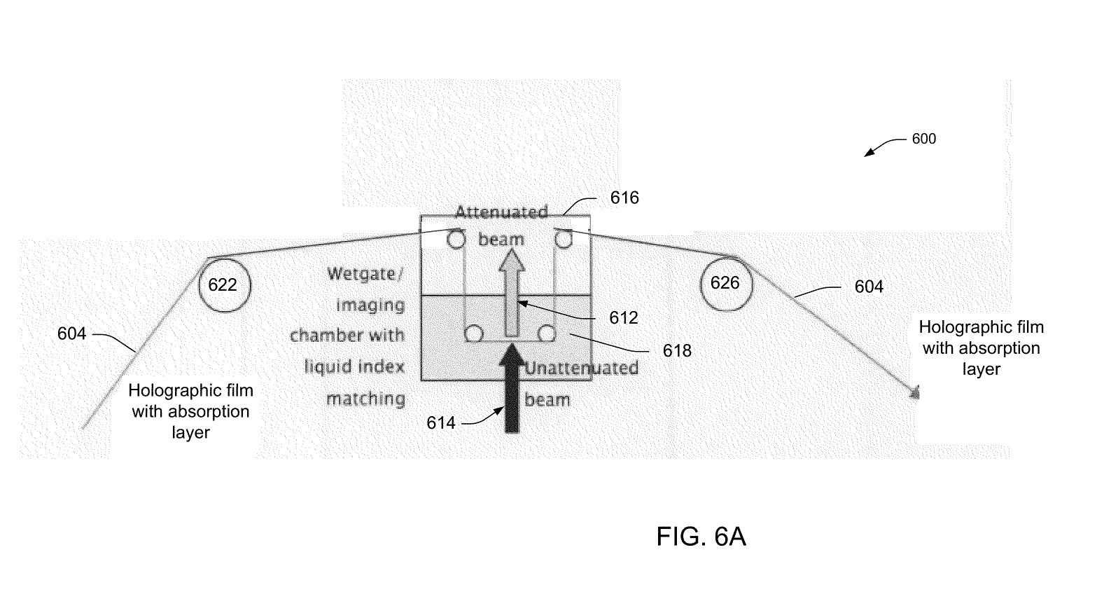

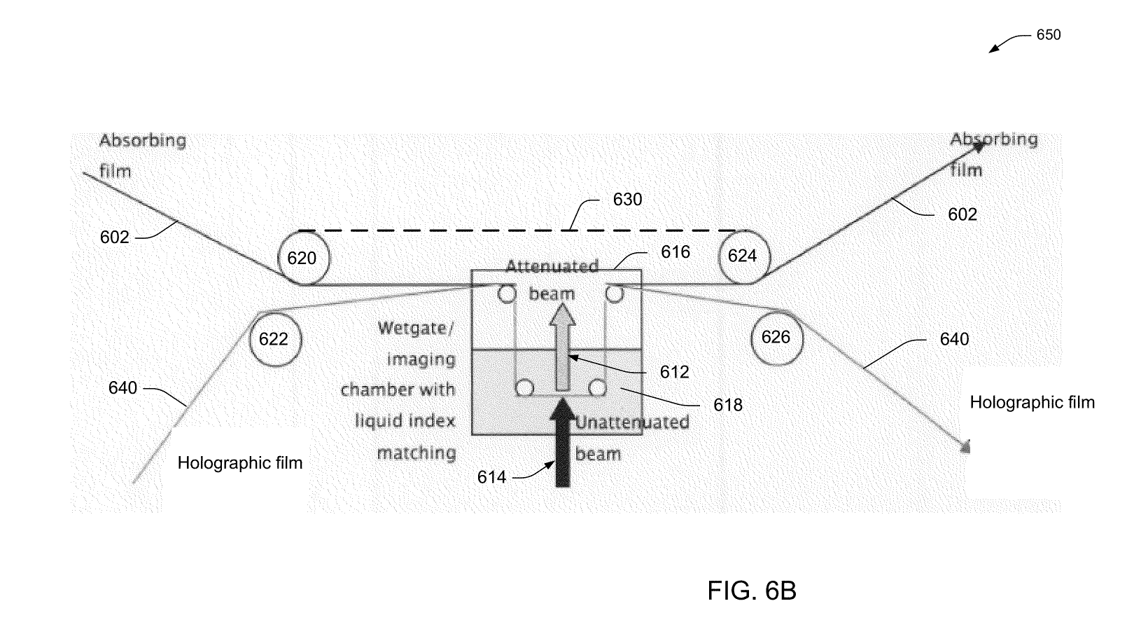

Once the absorbing film has been disposed on the holographic medium, the holographic medium can be exposed and a hologram generated, as indicated by block 712 of FIG. 7. In certain embodiments this is done via continuous processing using a system such as system 600 depicted in FIG. 6A. As is shown in FIG. 6A, holographic film 604, having an absorption layer according to the present invention, is fed from a source roll over an alignment roller 622 and into an imaging chamber 616 using a motorized feed mechanism. As the holographic film is conveyed through the imaging chamber 616, it is exposed by tight beam 614 while submerged in an index matching fluid 618. The portion of the light 614 that passes through the holographic film 604 is absorbed by the absorbing film 602. The amount of attenuated light 612 is thereby greatly reduced or eliminated as is the related occurrence of undesired exposure of the holographic film.

in certain embodiments the absorbing film is mechanically disposed on the holographic medium such that the holographic film and the absorbing film are maintained as separate structures. By “mechanically disposed” it is meant that the absorption layer of the absorption film is mechanically brought in contact with the holographic film prior to exposure as opposed to the holographic medium and absorbing medium being applied to the same substrate. In such embodiments, to generate the final hologram via continuous processing an alternative system such as system 650 of FIG. 6B may be used. As is illustrated, holographic film 640 is fed from a source roll over alignment roller 622 and into an imaging chamber using a motorized feed mechanism as previously described. At the same time, flexible light absorbing film 602 from a source roll is fed over an alignment roller 620 and into an imaging chamber. The holographic film 640 and the absorbing film 602 come into contact after entering the imaging chamber. The absorbing film is orientated such that the gelatin side contacts the holographic film. As the holographic film/absorption layer stack is conveyed through the imaging chamber 616, additional rollers ensure proper contact between the components in the stack and proper alignment with the light source. The stack is then exposed by light beam 614 while submerged in an index matching fluid 618.

The exposed holographic film 604 or 640 conveyed out of the imaging chamber is wound on a roll. Where a separate absorbing film is used, such as depicted in FIG. 6B, the absorbing film 602 conveyed out of the imaging chamber is wound on a separate roll. In such embodiments additional alignment rollers, such as rollers 624 and 626 may be used. In another embodiment, the separate absorbing film is formed in a continuous loop that is conveyed through the imaging chamber, as indicated by 630.

Where the absorption medium is disposed on the holographic medium, the absorption layer is removed after the holographic medium has been exposed, as indicated by block 714 of FIG. 7. In certain embodiments, the absorption layer is removed through the same process used to develop the holographic film and therefore no additional steps need be undertaken. In certain other embodiments, the exposed holographic film may be disposed in a separate aqueous solution in addition to the solution used to develop the holographic film.

While the invention is described through the above-described exemplary embodiments, it will be understood by those of ordinary skill in the art that modifications to, and variations of the illustrated embodiments may be made without departing from the inventive concepts disclosed herein.

For example, although some aspects of making and using Applicants' light absorbing film has been described, those skilled in the art should readily appreciate that functions, operations, decisions, etc., of all or a portion of each step, or a combination of steps, of the series of steps described may be combined, separated into separate operations or performed in other orders. Moreover, while the embodiments are described in connection with various illustrative structures, one skilled in the art will recognize that the light absorbing film can be embodied using a variety of structures. Furthermore, disclosed aspects, or portions of these aspects, may be combined in ways not listed above.

Furthermore, reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Additionally, the schematic flow charts included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Further, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Likewise, the described features, structures, or characteristics described herein may be combined in any suitable manner in one or more embodiments. In the above description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. Accordingly, the invention should not be viewed as being limited to the disclosed embodiment(s).

What is claimed is:

1. A light absorbing holographic film comprising:
a holographic medium; and
a light absorbing film disposed on the holographic medium, the light absorbing film comprising:
a substrate having a first surface; and
a first light absorption layer disposed on the first surface of the substrate.

2. The light absorbing holographic film of claim 1, wherein the light absorbing film is flexible.

3. The light absorbing holographic film of claim 1, wherein the substrate comprises polyethylene terephthalate (PET).

4. The light absorbing holographic film of claim 1, wherein the substrate has a thickness between approximately 50 microns and approximately 1,000 microns.

5. The light absorbing holographic film of claim 4, wherein the substrate has a thickness of approximately 100 microns.

6. The light absorbing holographic film of claim 1, wherein the first absorption layer comprises:
a gelatin; and
an absorption medium mixed with the gelatin.

7. The light absorbing holographic film of claim 6, wherein the first absorption layer comprises a colloidal mixture of the gelatin and the absorption medium.

8. The holographic film of claim 6, wherein the absorption medium is selected from the group comprising:
a dye;
a dichromate compound; and
a carbon black.

9. The light absorbing holographic film of claim 8, wherein the dichromate compound is selected from the group comprising potassium dichromate and ammonium dichromate.

10. The light absorbing holographic film of claim 6, wherein the gelatin comprises between approximately 40% water and approximately 90% water.

11. The light absorbing holographic film of claim 1, wherein the index of refraction of the first absorption layer is the same as the index of refraction of the substrate.

12. The light absorbing holographic film of claim 1, wherein the index of refraction of the first absorption layer is the same as the index of refraction of the unexposed film.

13. The light absorbing holographic film of claim 1, wherein the substrate has a second surface opposite the first surface, wherein the light absorbing film further comprises a second light absorption layer disposed on the second surface of the substrate.

14. The light absorbing holographic film of claim 13, wherein the first light absorption layer absorbs a first wavelength, wherein the second light absorption layer absorbs a second wavelength, wherein the first wavelength differs from the second wavelength.

15. The light absorbing holographic film of claim 14, wherein the first light absorption layer absorbs blue/green wavelengths, wherein the second light absorption layer absorbs red wavelengths.

16. The light absorbing holographic film of claim 1, wherein the first absorption layer has a first surface and a second surface, wherein the first surface of the absorption layer is adjacent to the substrate, wherein a second absorption layer is disposed on the second surface of the first absorption layer.

17. The light absorbing holographic film of claim 16, wherein the first light absorption layer absorbs a first wavelength, wherein the second light absorption layer absorbs a second wavelength, wherein the first wavelength differs from the second wavelength.

18. A system for processing holographic film, comprising:
a first source roll of flexible unexposed holographic film, the unexposed holographic film having a holographic medium;
a second source roll of flexible light absorbing film, comprising:
a substrate; and
a light absorption layer disposed on a first surface of the substrate;
an imaging chamber; and
a feed mechanism configured to bring a portion of the flexible light absorbing film into contact with a portion of the flexible unexposed holographic film within the imaging chamber prior to exposing the portion of the flexible unexposed holographic film to light.

19. The system of claim 18, further comprising a plurality of alignment rollers configured to align the flexible unexposed holographic film and the flexible light absorbing film as it moves through the system.

20. The system of claim 18 wherein the imaging chamber further comprises an indexing liquid, wherein the index of refraction of the indexing liquid is the same as the index of refraction of the flexible unexposed holographic film.

21. The system of claim 18, further comprising a light source, wherein the light source illuminates the portion of the flexible unexposed film in contact with the portion of the flexible light absorbing film within the imaging chamber.

22. A method for processing holographic film, comprising:
providing a light absorbing film, comprising:
a substrate having a first surface; and
a first light absorption layer disposed on the first surface of the substrate;
disposing the light absorbing film on a holographic medium; and
exposing the holographic medium to light.

23. The method of claim 22, wherein the first light absorption layer has a first surface opposite a second surface, wherein the first surface of the first light absorption layer is adjacent to the first surface of the substrate, the method further comprising disposing a second light absorption layer on the second surface of the first light absorption layer.

24. The method of claim 22, wherein the substrate has a second surface opposite the first surface of the substrate, the method further comprising disposing a second absorption layer on the second surface of the substrate.

25. The method of claim 22 further comprising removing the first absorption layer.

26. A light absorbing film for holographic processing comprising:
a substrate having a first surface; and
a first light absorption layer disposed on the first surface of the substrate, wherein the light absorption layer comprises a colloidal mixture of gelatin and an absorption medium.

27. The light absorbing film of claim 26, wherein the substrate has a second surface opposite the first surface, wherein the light absorbing film further comprises a second light absorption layer disposed on the second surface of the substrate.

28. The light absorbing film of claim 27, wherein the first light absorption layer absorbs a first wavelength, wherein the second light absorption layer absorbs a second wavelength, wherein the first wavelength differs from the second wavelength.

29. The light absorbing holographic film of claim 26, wherein the first absorption layer has a first surface and a second surface, wherein the first surface of the absorption layer is adjacent to the substrate, wherein a second absorption layer is disposed on the second surface of the first absorption layer.

30. The light absorbing film of claim 29, wherein the first light absorption layer absorbs a first wavelength, wherein the second light absorption layer absorbs a second wavelength, wherein the first wavelength differs from the second wavelength.
